(19) United States
(12) Patent Application Publication
(10) Pub. No.: US 2009/0118893 A1
(43) Pub. Date: May 7, 2009

(54) METHOD OF INTEGRATED DETECTION FOR AUTOMOBILE INSTRUMENTS

(76) Inventor: Xiuyu Che, Wei Fang (CN)

Correspondence Address: GLOBAL IP SERVICES, 7285 W. Eagle Court, Winton, CA, 95388, US

(21) Appl. No.: 11/934,877

(22) Filed: Nov. 5, 2007

(51) Int. Cl. G01M 17/00

(52) U.S. Cl. 701/29

(57) ABSTRACT

This Invention Makes Known by a Method of Integrated Detection for automobile instruments. Its characteristic is that the program-controlled signal generator sends out the signal. Then the signal is sent to the automobile instruments which need to be detected after power amplifying and amplitude regulation. Resistance signal system is composed of resistance flashboard and resistance control board. And it also sends the signal to the automobile instruments which need to be detected. Then the signal of the automobile instrument is detected by output voltage detection system to determine whether the automobile instrument is qualified or not. The efficiency of the automobile instruments detection is improved enormously by the above method. The method eliminates the error and miss phenomena which are produced by human factors, so that the automobile instruments will have quality assurance.

### FIELD OF THE INVENTION

Disclosed is a method of integrated detecting for automobile instructions.

### BACKGROUND OF THE INVENTION

Nowadays the reasons for constraining enterprises to product automobile instruments in large scale are a lot of automobile instrument models which own various parameters. Because of the higher levels of automobile instruments technology, maintenance and detection staff should possess the higher quality. And the staffs mainly use the power equipment, the calibration of signal generator instrument, resistance-box, multimeter etc. The above detective instruments link to each other to detect automobile instruments; The above method of detection for automobile instruments not only have many shortcomings like high labor intensity, mistakes, lower efficiency and high maintenance fee, not manageable etc, but also can not adapt the request of producing automobile instruments in large scale. In order to check the cause of the malfunction as soon as quickly, and to adapt the request of producing automobile instruments in large scale, we should use the fast and exact detection to solve the problems which is we should face with the technology now.

### SUMMARY OF THE INVENTION

This invention can solve the problem that is a method of checking automobile instructions. The method could simulate various signals of cars, so that the efficiency of detection and veracity will be enhanced. Soon the efficiency of production will be enhanced accordingly.

In order to solve the above technical problems, the technical scheme should be implemented as flows:

I. It provides constant DC power source for automobile instruments to make sure that the detection is implemented.

II. Automobile instructions are electronic speedometer, tachometer, gas gauge, water temperature gauge, manometer and soon on. They are detected by the signals which are provided from the analogue car. The analogue signals are: 1. Mileage sensor and rotational speed sensor produce square wave signals, but in this case square wave signals are produced by the signal generator which is controlled by the programs; 2. Oil scale sensor, water temperature sensor and pressure sensor (including oil pressure sensor, pressure sensor etc) produce the resistance signals, but in this case the resistance signals are produced by resistance signal system.

III. The signals, which are transmitted from automobile instruments to cars, are detected to make sure it will get the requirements. This step mainly detects the power signals which are produced by automobile instruments are transmitted to the car mileage sensor. The power signal is detected by output voltage supervising system.

The test efficiency of automobile instruments is enhanced enormously by the above detection method. The method eliminates the error and miss phenomena which are produced by human factors, so that the automobile instruments will have quality assurance.

### BRIEF DESCRIPTION OF THE DRAWINGS

The present invention will be better understood from reading the following drawings:

FIG. 1 illustrates the whole structure drawing.

FIG. 2 illustrates the flowchart of the program-controlled signal generator.

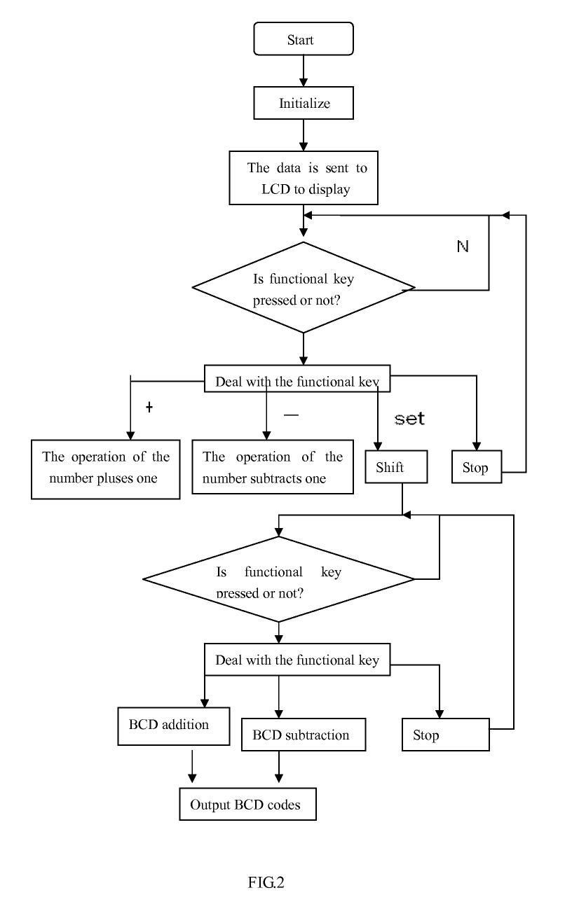

FIG. 3 illustrates the flow chart of the programs for the resistance signal system.

FIG. 4 illustrates the flow chart of the programs for output voltage supervising system.

### DETAILED DESCRIPTION OF THE INVENTION

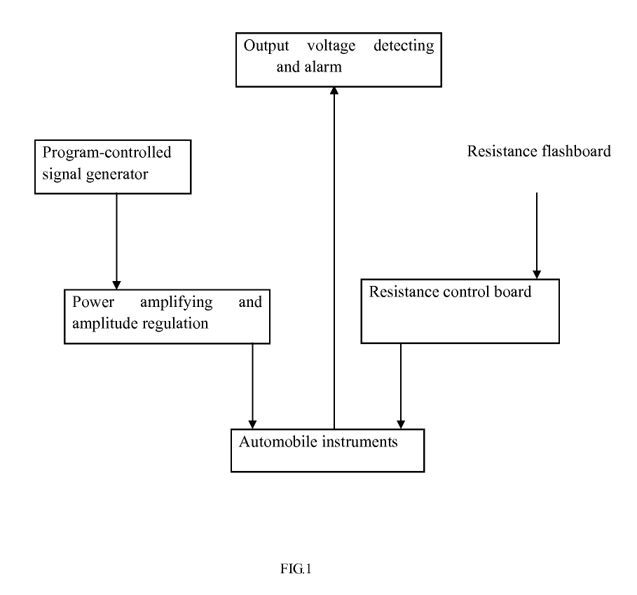

In FIG. 1, the program-controlled signal generator sends out the signal. Then the signal is sent to the automobile instruments which need to be detected after power amplifying and amplitude regulation. Resistance signal system is composed of resistance flashboard and resistance control board. And it also sends the signal to the automobile instruments which need to be detected. Then the signal of the automobile instrument is detected by output voltage detection system to determine whether the automobile instrument is qualified or not. Now we explain concretely the principle of producing analog signals and the principle of detecting automobile instruments output voltage with the drawings.

I. The Flow Chart and the Principle of the Program-Controlled Signal Generator:

The program-controlled signal generator simulates the signals of car mileage sensor and rotational speed sensor to detect automobile instructions. The signals, which are produced by the program-controlled signal generator, are sent to automobile instruments after amplified by power amplifier circuit and accommodated by the amplitude regulation circuit. At last the electronic speedometer and the tachometer are detected.

Program-controlled signal generator system mainly contains single-chip microcomputer PIC16F873A, parallel interface circuit 8255A-5, reference frequency generator, 4527 coefficient multiplier, 1621LCD monitor, ten-divider 74LS90, power source, amplitude regulation circuit, power amplifier circuit, keyboard etc. This signal generator could preset and display the frequency at the range of 1-10 kHz, at the same time it can implicate the functions which are increasing and decreasing the beforehand frequency along with the actual method of automobile instructions detection. So we can detect various automobile instructions only by presetting different frequencies.

The working principle is: the single-chip microcomputer 16F873A could control 8255-5 through analyzing and operating the information of the keyboard (to see the FIG. 1). 8255 output the BCD codes to control the BCD coefficient multiplier 4527 produce square signal. Then we could get ideal square signal after 74LS90 dividing frequency and integrating. The beforehand frequency and the output frequency are sent and displayed on LCD monitor in serial port by the single-chip microcomputer.

II. The Flow and the Principle of the Resistance Signal System:

Resistance signal system can output three routes resistance signal which possess error compensation. It can detect three automobile instructions which are in resistance signal. Resistance signal system is composed by resistance flashboard and resistance control board. The resistance control board is used to control the relative resistance values which are sent to automobile instruments. The resistance control board is composed by single-chip microcomputer PIC16F873A, 16 election analog switch CD4076, field effect tube IRF640, 12 election band switch. Resistance flashboard can chose different resistances to suit the requirements of different automobile instruments parameters.

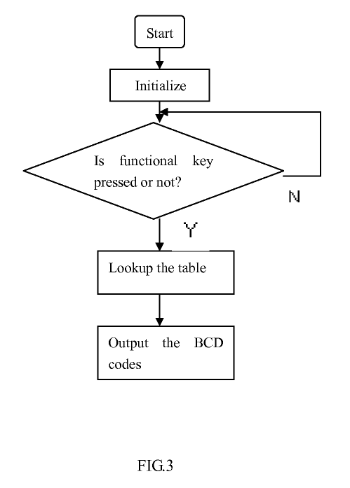

The working principle is: the single-chip microcomputer detects the state of band switch and the state of resistance compensate switch, and sends the BCD codes to control one road of simulate switch CD7067 output 12V which could conduct IRF640. Resistances, which are on the flashboard, are sent to the automobile instrument through IRF640 (to see FIG. 3). The accuracy of resistance is not affected because the on-resistance of IRF640 is very small.

III. The Flow Chart and the Principle of the Automobile Instructions Output Voltage Detecting System:

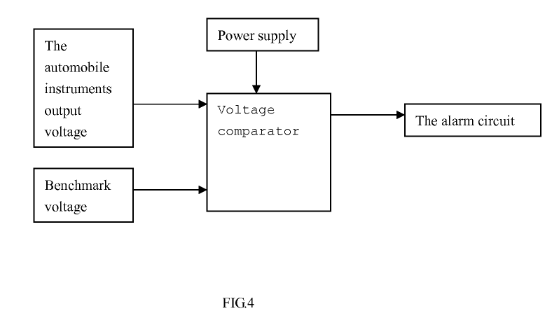

The automobile instructions output voltage detecting system uses the voltage comparing instrument to alarm. To see FIG. 4.

The working principle is: 741 can output high level that conduct transistor, then drive the buzzer to emit sound when the system detects voltage lower than the beforehand voltage.

What is claimed is:

1. A method of integrated detection for the automobile instruments comprising:
in a program-controlled signal generator, a single-chip microcomputer 16F873A could control a 8255-5 through analyzing and operating information of a keyboard;
the 8255 output BCD codes to control the BCD coefficient multiplier 4527 produce square signal;
get ideal square signal after 74LS90 dividing frequency and integrating;
the beforehand frequency and the output frequency are sent and displayed on LCD monitor in serial port by the single-chip microcomputer;
In a resistance signal system, a single-chip microcomputer detects the state of band switch and the state of resistance compensate switch, and sends the BCD codes to control one road of simulate switch CD7067 output 12V which could conduct IRF640; resistances, which are on the flashboard, are sent to the automobile instrument through IRF640;
In the output voltage detection system, 741 can output high level that conduct transistor, then drive the buzzer to emit sound when the system detects voltage lower than the beforehand voltage.
